(19) United States
(12) Patent Application Publication
(10) Pub. No.: US 2006/0287799 A1
(43) Pub. Date: Dec. 21, 2006

(54) Active vibration insulator

(75) Inventors: Hiroyuki Ichikawa, Kani-shi (JP); Takayoshi Yasuda, Iwakura-shi (JP); Takehiko Fushimi, Kariya-shi (JP); Daichi Mizushima, Anjo-shi (JP); Kenichi Sato, Nagoya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: TOKAI RUBBER INDUSTRIES, LTD., Komaki-shi (JP)

(21) Appl. No.: 11/450,277

(22) Filed: Jun. 12, 2006

(30) Foreign Application Priority Data
Jun. 15, 2005 (JP) 2005-175317

(51) Int. Cl. G06F 17/00

(52) U.S. Cl. 701/93; 701/1

(57) ABSTRACT

An active vibration insulator includes an electromagnetic actuator, a control-signals generator, a control-signals compensator, and a driver. The electromagnetic actuator generates vibrating forces depending on electric-current supplies. The control-signals generator generates control signals, which actively inhibit vibrations generated by a vibration generating source of a vehicle from transmitting to a specific part of the vehicle, based on cyclic pulsating signals output from the vibration generating source. The control-signals compensator compensates the cyclic control signals, which the control-signals generator generates, depending on output voltages of a battery. The driver is connected between the battery and the electromagnetic actuator, and makes the electric-current supplies variable based on the cyclic control signals, which the control-signals compensator has compensated, and the output voltages of the battery, thereby driving the electromagnetic actuator.

### BACKGROUND OF THE INVENTION

1. Field of the Invention

The present invention relates to an active vibration insulator, especially, an active vibration insulator for actively inhibiting the vibrations of vibration generating sources, such as vehicle engines, from transmitting.

2. Description of the Related Art

Active vibration insulators actively inhibit the vibrations of vehicle engines from transmitting. For example, Japanese Unexamined Patent Publication (KOKAI) No. 2001-1,768 discloses such a conventional active vibration insulator, which inhibits the vibration of engines from transmitting by actively actuating an electromagnetic actuator carried on an engine mount. The electromagnetic actuator is driven based on cyclic control signals whose amplitudes and phases are compensated by means of changed or updated filter coefficients. Note that the filter coefficients are updated, for instance, using the angular frequencies of cyclic pulsating signals, which are output from a rotary detector for detecting the revolutions of engines, and map data which are stored in advance. Specifically, in this instance, the cyclic control signals are generated based on the angular frequencies and map data.

However, the temperature around the engine mount, which is equipped with the electromagnetic actuator controlled by the active vibration insulator, changes so that the impedance of the electromagnetic actuator changes. Accordingly, the filter coefficients, which are used to generate the cyclic control signals, have come to deviate from their optimum values. Consequently, there arises a problem that the active vibration insulator might control the electromagnetic actuator in a fluctuating manner.

In view of the problem, Japanese Unexamined Patent Publication (KOKAI) No. 2001-1,768 solves the problem as follows. A datum electric-current value is stored in advance for each of predetermined frequencies. Then, an electric-current value, which corresponds to a cyclic control signal generated using the map data, is compared with the datum electric-current value, which depends on the frequency of the electric-current value. When the error, which results from the difference between the electric-current value and the datum electric-current value, is large, a cyclic control signal is re-generated with a filter coefficient, which is based on the datum electric-current value. Thus, the electromagnetic actuator is driven using the re-generated cyclic control signal. On the other hand, when the error, which results from the difference between the electric-current value and the datum electric-current value, is small, the electromagnetic actuator is driven using the cyclic control signal, which has been generated already.

As a result, according to Japanese Unexamined Patent Publication (KOKAI) No. 2001-1,768, the conventional active vibration insulator can control the electromagnetic actuator properly even when the temperature change around the engine mount has resulted in the impedance change of the electromagnetic actuator, because the conventional active vibration insulator can generate optimum cyclic control signals.

However, a battery for applying a voltage to the electromagnetic actuator of an active vibration insulator is disposed in a vehicle engine room in general. That is, the changing temperature around an engine mount has resulted in changing the temperature around the battery. Even when the battery is not disposed in a vehicle engine room, it is probable, of course, that the temperature around the battery changes. Moreover, as the temperature around the battery changes, the output voltage of the battery changes as well. For example, when the temperature around the battery is low, the battery outputs lower voltages than it does when the temperature around the battery is high.

Moreover, a battery is connected to a plurality of on-vehicle components, which include an active vibration insulator. Specifically, in addition to an active vibration insulator, a battery applies voltages to various on-vehicle component parts, such as an air conditioner, head lights and an electric power steering apparatus, for instance. Therefore, the battery outputs a voltage, which changes depending on the service conditions of the on-vehicle component parts.

Note herein that the output voltage of a battery, which changes depending on the temperature change around the battery and the service conditions of the on-vehicle component parts, affect the vibrating forces, which the electromagnetic actuator of an active vibration insulator generates. For example, when the output voltage of a battery drops, the vibrating forces, which the electromagnetic actuator of an active vibration insulator, have lowered. Thus, there might arise a fear conventionally that the electromagnetic actuator of an active vibration insulator cannot generate an appropriate vibrating force because of the changing output voltage of a battery. If the vibrating forces, which the electromagnetic actuator of an active vibration insulator generates, should have been inappropriate, it is not possible to inhibit the vibrations of an engine from transmitting to the other parts of a vehicle. Accordingly, the noise/vibration performance (hereinafter abbreviated to as “N/V performance”) of the vehicle might have degraded so that the ride quality of the vehicle might have deteriorated. Moreover, if it should have been possible or impossible to inhibit the vibrations of an engine from transmitting to the other parts of a vehicle depending on the changing output voltage of a battery, it results in varying the vibrations and/or noises of the engine, which vehicle passengers sense. Consequently, the changing vibrations and/or noises of an engine, which vehicle passengers sense, might result in deteriorating the ride quality of a vehicle.

### SUMMARY OF THE INVENTION

The present invention has been developed in view of the aforementioned circumstance. It is therefore an object of the present invention to provide an active vibration insulator which can generate appropriate vibrating forces even when a battery outputs changing voltages.

An active vibration insulator according to the present invention comprises:

an electromagnetic actuator for generating vibrating forces depending on electric-current supplies;

a control-signals generator for generating control signals, which actively inhibit vibrations generated by a vibration generating source of a vehicle from transmitting to a specific part of the vehicle, based on cyclic pulsating signals output from the vibration generating source;

a control-signals compensator for compensating the cyclic control signals, which the control-signals generator generates, depending on output voltages of a battery; and

a driver, connected between the battery and the electromagnetic actuator, for making the electric-current supplies variable based on the cyclic control signals, which the control-signals compensator has compensated, and the output voltages of the battery, thereby driving the electromagnetic actuator.

In the present active vibration insulator, the driver comprises a pulse-width modulation (hereinafter abbreviated to as “PWM” converter, and a switching circuit, for instance. The PWM converter converts input signals into PWM signals based on the cyclic control signals, which the control-signals compensator has compensated. The switching circuit comprises a plurality of switching devices. The switching devices are actuated based on the PWM signals, which the PWM controller outputs, and thereby supply electric currents to the electromagnetic actuator. That is, the switching devices of the switching circuit actuate the driver virtually under PWM control depending on the cyclic control signals, which the control-signals compensator has compensated. Moreover, the switching circuit is connected to the battery. That is, the electric currents, which the driver supplies to the electromagnetic actuator, are determined by how much voltage the battery outputs and how the switching elements are actuated. Specifically, the electric-current supplies to the electromagnetic actuator are determined by the cyclic control signals, which the control-signals compensator has compensated, and the output voltages of the battery. Thus, the changing output voltages of the battery affect the electric-current supplies to the electromagnetic actuator.

Note herein that the control-signals compensator compensates the cyclic control signals, which the control-signals generator generates, depending on the output voltages of the battery. Specifically, the thus compensated cyclic control signals are signals which take the changing output voltages of the battery into consideration. Accordingly, the cyclic control signals, which the control-signals generator generates, can be compensated in advance so that the actual electric-current values, which the driver supplies to the electromagnetic actuator, are free from the influence of the changing output voltages of the battery. Consequently, it is possible to inhibit the changing output voltages of the battery from adversely affecting the electric-current supplies to the electromagnetic actuator. That is, even when the output voltages of the battery change depending on the temperature change around the battery or the service conditions of the on-vehicle component parts, the electromagnetic actuator can generate appropriate vibrating forces.

As a result, even when the output voltages of the battery change, it is possible to make the N/V performance of the vehicle satisfactory so as to upgrade the ride quality of the vehicle. Moreover, it is possible to inhibit the vibrations and/or noises of an engine, which vehicle passengers sense, from varying. In view of this advantageous operation as well, it is possible to furthermore upgrade the ride quality of the vehicle.

Moreover, it is advisable that the control-signals compensator can compensate the cyclic control signals, which the control-signals generator generates, smaller when the output voltages of the battery are larger; and compensates the cyclic control signals, which the control-signals generator generates, larger when the output voltages of the battery are smaller. Usually, the smaller the output voltages of the battery are the less the electric-current values, which the driver supplies to the electromagnetic actuator, are. Therefore, by thus letting the control-signals compensator compensate the cyclic control signals larger when the output voltages of the battery are smaller, it is possible to securely inhibit the changing voltages of the battery from adversely affecting the electric-current values, which the driver supplies to the electromagnetic actuator.

In addition, it is advisable that the control-signals compensator can compensate the cyclic control signals, which the control-signals generator generates, so as to be in proportion to the reciprocal numbers of the output voltages of the batter. By carrying out such a very simple calculation, it is possible to make appropriate compensations to the cyclic control signals, which the control-signals generator generates.

The present active vibration insulator can have the electromagnetic actuator generate appropriate vibrating forces, even when the temperature around the battery changes or the service conditions of the on-vehicle component parts change so that the battery outputs changing voltages, without being adversely affected by the change of the battery's output voltages. As a result, even when the output voltages of the battery change, the present active vibration insulator can make the N/V performance of the vehicle satisfactory so that the ride quality of the vehicle can be upgraded. Moreover, the present active vibration insulator can inhibit the vibrations and/or noises of an engine, which vehicle passengers sense, from varying. In view of this advantageous operation as well, the present active vibration insulator can furthermore upgrade the ride quality of the vehicle.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a block diagram for illustrating an arrangement of an active vibration insulator 1 according to an example of the present invention.

FIG. 2 illustrates a cross-sectional view of an engine mount 20 of the active vibration insulator 1.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

The present invention will be hereinafter described in more detail while naming its specific embodiments.

### (1) Arrangement of Active Vibration Insulator 1

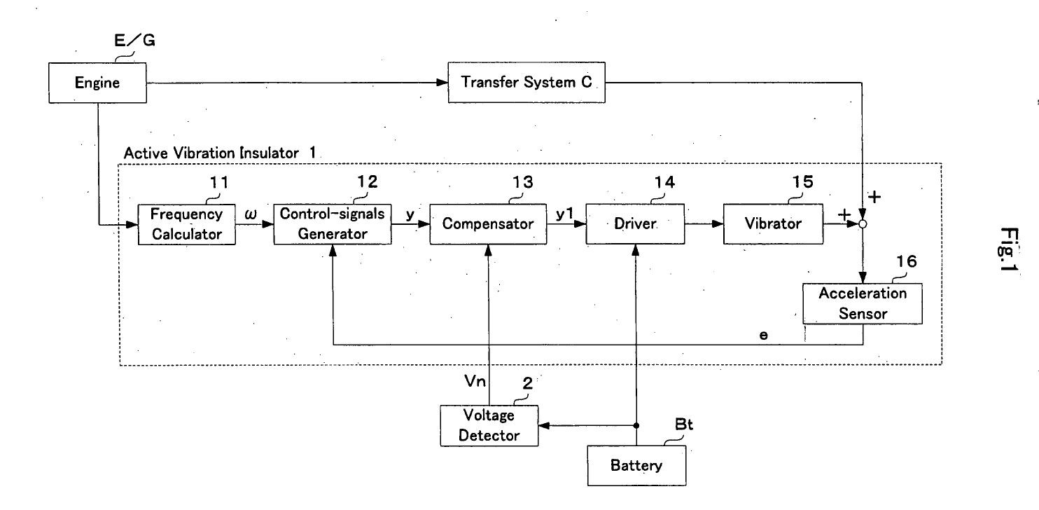

An arrangement of an active vibration insulator 1 according to an example of the present invention will be hereinafter described with reference to FIG. 1. FIG. 1 is a block diagram for illustrating an arrangement of the active vibration insulator 1. The active vibration insulator 1 is an apparatus for actively inhibiting vibrations, which an engine E/G (i.e., claimed vibration generating source) carried on a vehicle generates, from transmitting to the vehicle's specific parts. As illustrated in FIG. 1, the active vibration insulator 1 comprises a frequency calculator 11, a control-signals generator 12, a compensator 13, a driver 14, a vibrator 15, and an acceleration sensor 16.

The frequency calculator 11 receives cyclic pulsating signals, which are output from a rotary detector (not shown) for detecting the revolutions of the engine E/G. Then, the frequency calculator 11 calculates the angular frequencies ω of the cyclic pulsating signals based on the input cyclic pulsating signals.

The control-signals generator 12 receives the angular frequencies ω of the cyclic pulsating signals, which the frequency calculator 11 calculates. Then, the control-signals generator 12 selects either one of a map control mode and an adaptive control mode based on the angular frequencies ω of the input cyclic pulsating signals. Thus, the control-signals generator 12 generates a cyclic control signal y by means of one of selected modes, that is, a map control mode or an adaptive control mode. When the map control mode is selected, the control-signals generator 12 generates a cyclic control signal y based on the angular frequencies ω of the cyclic pulsating signals and map data, which are stored in advance. On the other hand, when the adaptive control mode is selected, the control-signals generator 12 generates a cyclic control signal y based on the calculated angular frequencies ω of the cyclic pulsating signals and an error signal e, which the acceleration sensor 16 detects, by means of an adaptive control method. Note that these cyclic control signals y are signals, which enable the active vibration insulator 1 to actively inhibit the vibrations, which the engine E/G generates at the installation location of the acceleration sensor 16, from transmitting to the vehicle's specific parts.

The compensator 13 (i.e., claimed control-signals compensator) receives the cyclic control signal y, which the control-signals generator 12 generates, and output voltages Vn of a battery Bt, which a voltage detector 2 detects. Then, the compensator 13 compensates the cyclic control signal y according to equation (1). That is, the resultant compensated cyclic control signal y1 is a signal, which takes the output voltages Vn of the battery Bt into consideration with respect to the original or prior-to-compensation cyclic control signal y. Specifically, the compensated cyclic control signal y1 is in proportion to the original or prior-to-compensation cyclic control signal y by a factor of proportional constant, the reciprocal numbers of the battery Bt's output voltages Vn.

Equation 1
y1=y×Vst/Vn (1)

y1: Compensated Cyclic Control Signal

y: Original or Prior-to-Compensation Cyclic Control Signal

Vst: Datum Voltage (V)

Vn: Output Voltage of Bt (V)

Note herein that, in addition to the active vibration insulator 1, the battery Bt is connected to various on-vehicle component parts, such as an air conditioner, head lights and an electric power steering apparatus. Therefore, the battery Bt's output voltages Vn change accordingly depending on the service conditions of the on-vehicle component parts. For example, when the datum voltage Vst in equation (1) is 13 V, and when an output voltage of the battery Bt is 13 V, the compensated cyclic control signal y1 coincides with the original or prior-to-compensation cyclic control signal y. On the other hand, when an output voltage of the battery Bt is reduced to 10 V, the compensated cyclic control signal y1 is increased to the original or prior-to-compensation cyclic control signal y by about 1.3 times. Moreover, when an output voltage of the battery Bt is increased to 16 V, the compensated cyclic control signal y1 is reduced to the original or prior-to-compensation cyclic control signal y by about 0.8 times.

The driver 14 is disposed between the battery Bt and the vibrator 15 to connect them. The driver 14 actuates the vibrator 15 based on the compensated cyclic control signal y1, which the compensator 13 outputs to the driver 14, and the voltages, which the battery Bt applies to the driver 14. Specifically, the driver 14 comprises a PWM converter and a switching circuit. The PWM converter converts the input compensated cyclic control signal y1 into a PWM signal comprising a duty, which depends on the input compensated cyclic control signal y1 received by the driver 14. The switching circuit comprises a bridge circuit, which is provided with a plurality of switching devices. The positive and negative terminals of the switching circuit's input side is connected to the battery Bt, and the positive and negative terminals of the switching circuit's output side is connected to the vibrator 15. Thus, the switching devices are actuated based on the PWM signal, which the PWM converter outputs, and supply an electric current to the vibrator 15 accordingly.

Note herein that the electric current, which the switching circuit of the driver 14 supplies to the vibrator 15, changes according to the compensated cyclic control signal y1 and the output voltages Vn of the battery Bt. That is, the electric current, which the switching circuit supplies to the vibrator 15, is in proportion to the compensated cyclic control signal y1 virtually, and is in proportion to the output voltages Vn of the battery Bt as well. Specifically, the larger the compensated cyclic control signal y1 is the larger the electric-current supply to the vibrator 15 is. Moreover, the larger the output voltages Vn of the battery Bt are the larger the electric-current supply to the vibrator 15 is.

However, the compensated cyclic control signal y1 has been produced by compensating the original or prior-to-compensation cyclic control signal y according to equation (1) as described above. Specifically, the compensated cyclic control signal y1 is in proportion to the original or prior-to-compensation cyclic control signal y by a factor of the reciprocal numbers of the output voltages Vn of the battery Bt. On the other hand, the electric current, which the switching circuit of the driver 14 supplies to the vibrator 15, is in proportion to the compensated cyclic control signal y1 as well as the output voltages Vn of the battery Bt virtually. To put it differently, the electric current, which the switching circuit of the driver 14 supplies to the vibrator 15, is in proportion to the original or prior-to-compensation cyclic control signal y virtually. This results from the fact that the relationship between the original or prior-to-compensation cyclic control signal y and the output voltages Vn of the battery Bt at the compensator 13, and the relationship between the compensated cyclic control signal y1 and the output voltages Vn of the battery Bt cancel to each other. Therefore, even when the output voltages Vn of the battery Bt change, the changing output voltages Vn of the battery Bt do not influence the electric current, which the switching circuit of the driver 14 supplies to the vibrator 15, at all.

The vibrator 15 (i.e., claimed electromagnetic actuator) comprises a solenoid which is carried on an engine mount 20, which will be described later, for example. The solenoid, the vibrator 15, generates vibrating forces, depending on electric-current supplies, which change cyclically, to its coil. That is, cyclically changing the electric-current supply to the coil of the solenoid, the vibrator 15, can vary the vibrating forces, which the vibrator 15 generates. In other words, when the vibrations, which the engine E/G generates, and the vibrations, which the vibrator 15 generates, cancel to each other completely, for instance, the vibrations of the engine E/G are not transmitted from the engine mount 20 to the vehicle-body side at all.

The acceleration sensor 16 is installed to a fixing part, one of the parts of the later-described engine mount 20, at which the engine mount 20 is fixed to an engine frame E/F. That is, the acceleration sensor 16 detects vibrations at the fixing part, one of the parts of the engine mount 20, which is fixed to the engine frame E/F. Specifically, the acceleration sensor 16 detects vibrations (hereinafter referred to as “error signals”) e which are produced by synthesizing the vibrations of the engine E/G, which are transmitted by way of a transfer system C, and the vibrations, which the vibrator 15 generates. The acceleration sensor 16 outputs the error signals e to the control-signals generator 12. The resulting error signals e are used when the control-signals generator 12 selects the adaptive control mode as described above.

### (2) Detailed Arrangement of Engine Mount 20 Comprising Vibrator 15 and Acceleration Sensor 16

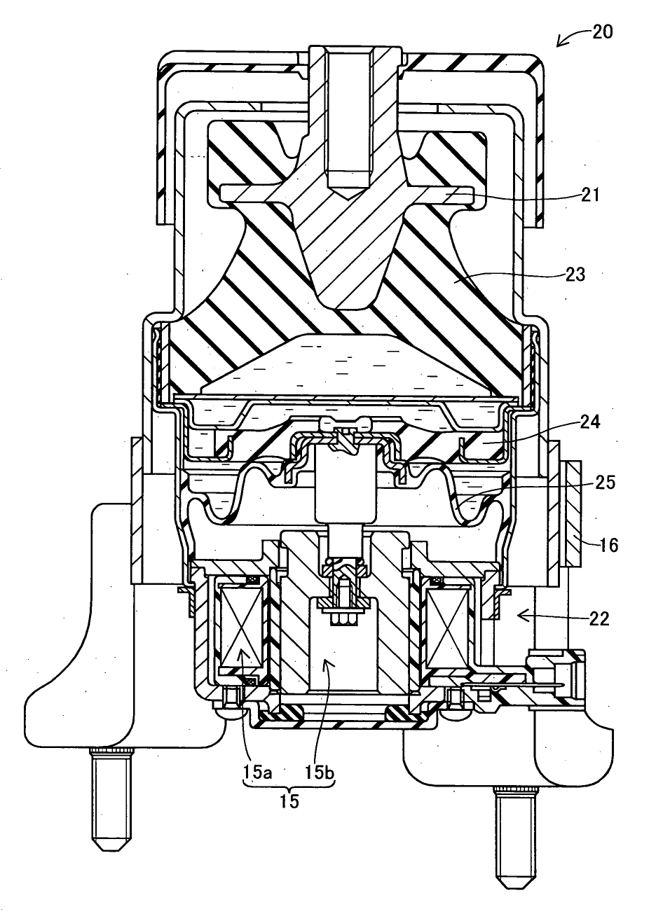

Subsequently, a detailed arrangement of the engine mount 20, which comprises the vibrator 15 and the acceleration sensor 16, will be hereinafter described with reference to FIG. 2. FIG. 2 illustrates a cross-sectional view of the engine mount 20.

As shown in FIG. 2, the engine mount 20 comprises a first fixture fitting 21, a second fixture fitting 22, a main rubber elastic body 23, a vibratable plate 24, a diaphragm 25, the vibrator 15, and the acceleration sensor 16.

The first fixture fitting 21 is a first component member to be installed to the engine E/G. The second fixture fitting 22 is formed as a substantially cylinder shape, and is a second component member to be installed to the engine frame E/F. Moreover, the first fixture fitting 21 and the second fixture fitting 22 are separated away from each other, and are disposed to face to each other. In addition, the main rubber elastic body 23 interposes between the first fixture fitting 21 and the second fixture fitting 22 to elastically connect the first fixture fitting 21 with the second fixture fitting 22.

The vibratable plate 24 is formed as a substantially disk shape, and is made of rubber. The vibratable plate 24 is disposed within the second fixture fitting 22 and under the main rubber elastic body 23 in FIG. 2. The vibratable plate 24 and main rubber elastic body 23 form a pressure receiving chamber into which the vibrations emitted from the engine E/G are input. Moreover, the diaphragm 25 is formed of a thin-thickness rubber elastic film so that it is deformable readily. The diaphragm 25 is disposed within the second fixture fitting 22 and under the vibratable plate 24 in FIG. 2. The diaphragm 25 and vibratable plate 24 form an equilibrium chamber which is allowed to undergo volume change with ease. Note that a noncompressible fluid is sealed in the pressure receiving chamber and in the equilibrium chamber. Also note that an orifice passage communicates the pressure receiving chamber with the equilibrium chamber.

The vibrator 15, a solenoid, comprises a substantially-cylinder-shaped core 15a, and a substantially-column-shaped plunger 15b disposed at the center of core 15a. The core 15a forms a coil in which a winding wire is wound, and is fixed to an inner peripheral surface of the second fixture fitting 22 and under the diaphragm 25 in FIG. 2. The plunger 15b is disposed movably with respect to the core 15a axially (or in the up/down direction in FIG. 2). The plunger 15b is fixed to the vibratable plate 24 on the upper opposite-end side in FIG. 2. That is, the vibrator 15 operates to pull the plunger 15b downward in FIG. 2, depending on the electric-current supplies to the coil or winding wire of the core 15a. Thus, the vibratable plate 24 deforms to carry out the pressure control of the pressure receiving chamber, as the plunger 15b reciprocates axially. Moreover, by appropriately deforming the vibratable plate 24 actively to actively change the pressure within the pressure receiving chamber, it is possible to inhibit the vibrations of the engine E/G from transmitting to the engine frame E/F.

The acceleration sensor 16 is fixed to an outer periphery of the second fixture fitting 22. That is, the acceleration sensor 16 meters the vibrations of the second fixture fitting 22 of the engine mount 20.

The thus arranged active vibration insulator 1 according to an example of the present invention comprises the compensator 13, which inhibits the battery Bt's changing output voltages Vn from adversely affecting the electric-current supplies to the vibrator 15's coil or winding wire. Therefore, even when the output voltages Vn of the battery Bt change depending on the service conditions of the on-vehicle component parts, the vibrator 15 can generate appropriate vibrating forces. As a result, the active vibration insulator 1 can make the N/V performance of the vehicle satisfactory so that the ride quality of the vehicle can be upgraded. Moreover, the active vibration insulator 1 can furthermore upgrade the ride quality of the vehicle, because it can inhibit the vibrations and/or noises of the vehicle's engine, which vehicle passengers sense, from changing.

### Modified Version

In the above-described active vibration insulator 1 according to an example of the present invention, the map control mode is switched to the adaptive control mode, or vise versa. However, the present invention is not limited to such a specific example. For example, the active vibration insulator 1 can employ the map control mode alone, or can employ the adaptive control mode alone.

Having now fully described the present invention, it will be apparent to one of ordinary skill in the art that many changes and modifications can be made thereto without departing from the spirit or scope of the present invention as set forth herein including the appended claims.

What is claimed is:

1. An active vibration insulator, comprising:
an electromagnetic actuator for generating vibrating forces depending on electric-current supplies;
a control-signals generator for generating control signals, which actively inhibit vibrations generated by a vibration generating source of a vehicle from transmitting to a specific part of the vehicle, based on cyclic pulsating signals output from the vibration generating source;
a control-signals compensator for compensating the cyclic control signals, which the control-signals generator generates, depending on output voltages of a battery; and
a driver, connected between the battery and the electromagnetic actuator, for making the electric-current supplies variable based on the cyclic control signals, which the control-signals compensator has compensated, and the output voltages of the battery, thereby driving the electromagnetic actuator.

2. The active vibration insulator set forth in claim 1, wherein the control-signals compensator compensates the cyclic control signals, which the control-signals generator generates, smaller when the output voltages of the battery are larger; and compensates the cyclic control signals, which the control-signals generator generates, larger when the output voltages of the battery are smaller.

3. The active vibration insulator set forth in claim 2, wherein the control-signals compensator compensates the cyclic control signals, which the control-signals generator generates, so as to be in proportion to the reciprocal numbers of the output voltages of the battery.
